(19) United States
(12) Patent Application Publication
(10) Pub. No.: US 2013/0063965 A1
(43) Pub. Date: Mar. 14, 2013

(54) LIGHT GUIDE PLATE AND BACKLIGHT MODULE

(71) Applicant: Tian Zhang, Shenzhen (CN)

(72) Inventor: Tian Zhang, Shenzhen (CN)

(73) Assignee: SHENZHEN CHINA STAR OPTOELECTRONICS TECHNOLOGY CO.,LTD., Shenzhen, Guangdong (CN)

(21) Appl. No.: 13/379,656

(22) PCT Filed: Oct. 31, 2011
(86) PCT No.: PCT/CN2011/081588

§ 371 Date: Dec. 21, 2011

(30) Foreign Application Priority Data
Sep. 14, 2011 (CN) 201120341930.5
Oct. 31, 2011 (CN) PCT/CN2011/081588

(51) Int. Cl. G09F 13/18; F21V 7/05

(52) U.S. Cl. 362/602; 362/624

(57) ABSTRACT

A light guide plate is disclosed which comprises a bottom surface and a reflective layer. The bottom surface is formed with a plurality of mesh points, and a density of the mesh points increases with a distance from a light source. The reflective layer is a sputtered film formed on the bottom surface. A corresponding backlight module is further disclosed. The light guide plate and other components of the backlight module can be pushed into the backplate from a side, so they are easy to be assembled, thus improving the yield of the backlight module.

### BACKGROUND

1. Technical Field

The present disclosure relates to the field of liquid crystal displaying, and more particularly, to a light guide plate and a backlight module.

2. Description of Related Art

A liquid crystal display (LCD) device generally comprises an LCD panel and a backlight module. As LCD devices are evolving towards a lighter weight and a thinner profile, the backlight module must be made to be thinner. FIG. 1 is a schematic cross-sectional view of a conventional backlight module. As shown in FIG. 1, the backlight module comprises a light guide plate 1, a light source 2, a reflective sheet 4, a diffuser sheet 6, a prism sheet 7, a backplate 8 and other parts (not shown). The light guide plate 1 comprises a bottom surface and mesh points 5 disposed on the bottom surface. The reflective sheet 4 is made of a PET or PC substrate, and is disposed at the bottom of the light guide plate 1 to reflect light leaked from the bottom surface of the light guide plate 1 back into the light guide plate 1; and in this way, the light leakage can be prevented to improve the utilization factor of the light. In order to assemble the backlight module, the light guide plate 1, the reflective sheet 4, the diffuser sheet 6 and the prism sheet 7 are firstly laminated together and then placed into the backplate 8. However, it is easy to cause damage to the components during the assembling process, and the complex assembling process has an adverse effect on the product yield.

### BRIEF SUMMARY

The primary objective of the present disclosure is to provide a light guide plate and a backlight module that can improve the assembling efficiency of the backlight module.

The present disclosure provides a light guide plate, which comprises a bottom surface and a reflective layer. The bottom surface is formed with a plurality of mesh points. A density of the mesh points increases with a distance from a light source. The reflective layer is a sputtered film formed on the bottom surface.

Preferably, the sputtered film is formed on a surface of each of the mesh points.

Preferably, the sputtered film is formed of one of silver (Ag), aluminum (Al), copper (Cu), chromium (Cr), and any alloys thereof.

Preferably, the sputtered film is formed of one of silver (Ag), aluminum (Al), copper (Cu), chromium (Cr), and any alloys thereof.

The present disclosure further provides a backlight module, which comprises a light guide plate and a light source. The light guide plate comprises a light incident surface, a bottom surface and a reflective layer. The light source is disposed at the side of the light incident surface. The reflective layer is a sputtered film formed on the bottom surface.

Preferably, the sputtered film is formed on a surface of each of the mesh points.

Preferably, the sputtered film is formed of one of silver (Ag), aluminum (Al), copper (Cu), chromium (Cr), and any alloys thereof.

Preferably, the sputtered film is formed of one of silver (Ag), aluminum (Al), copper (Cu), chromium (Cr), and any alloys thereof.

Preferably, a density of the sputtered film increases with a distance from the light source.

Preferably, a density of the sputtered film increases with a distance from the light source.

Preferably, the backlight module further comprises a backplate. The backplate is formed with two grooves at two sides respectively, and the light guide plate is snap-fitted in the two grooves and fixed to the backplate by means of movable screws or movable studs.

Preferably, the backlight module further comprises a backplate. The backplate is formed with two grooves at two sides respectively, and the light guide plate is snap-fitted in the two grooves and fixed to the backplate by means of movable screws or movable studs.

Preferably, the backplate is a hollow structure.

Preferably, the backplate is formed by two L-shaped metal plates welded together.

The present disclosure further provides a backlight module, which comprises a light guide plate, a light source and a backplate. The light guide plate comprises a light incident surface, a bottom surface and a reflective layer. The light source is disposed at the side of the light incident surface. The light guide plate is formed with a plurality of mesh points on a bottom surface thereof. A density of the mesh points increases with a distance from the light source. The reflective layer is a sputtered film formed on the bottom surface, and a density of the sputtered film increases with a distance from the light source.

The backplate is formed with two grooves at two sides respectively, and the light guide plate is snap-fitted in the two grooves and fixed to the backplate by means of movable screws or movable studs.

Preferably, the sputtered film is formed on a surface of each of the mesh points.

Preferably, the sputtered film is formed of one of silver (Ag), aluminum (Al), copper (Cu), chromium (Cr), and any alloys thereof.

Preferably, the sputtered film is formed of one of silver (Ag), aluminum (Al), copper (Cu), chromium (Cr), and any alloys thereof.

Preferably, the backplate is a hollow structure.

Preferably, the backplate is formed by two L-shaped metal plates welded together.

According to the light guide plate and the backlight module of the present disclosure, a reflective material is sputtered onto the mesh points or the bottom surface of the light guide plate to form a reflective layer, so the reflective sheet can be removed from the backlight module to reduce the thickness of the backlight module. As a result, components of the backlight module can be pushed in from a side of the backplate during the assembling process, which reduces the complexity in assembling the backlight module and improves the product yield.

### BRIEF DESCRIPTION OF THE DRAWINGS

FIG. 1 is a schematic partial cross-sectional view of a backlight module in the prior art;

FIG. 2 is a schematic partial cross-sectional view of a backlight module according to a first embodiment of the present disclosure;

FIG. 3 is a schematic partial cross-sectional view of the backlight module according to a second embodiment of the present disclosure;

FIG. 4 is a side view of a backplate of the backlight module according to the present disclosure;

FIG. 5 is a perspective view of the backplate of the backlight module according to the present disclosure;

FIG. 6 is an assembly diagram of the backlight module according to the present disclosure;

FIG. 7 is a schematic view illustrating a backplate of the backlight module of the present disclosure that is a hollow structure.

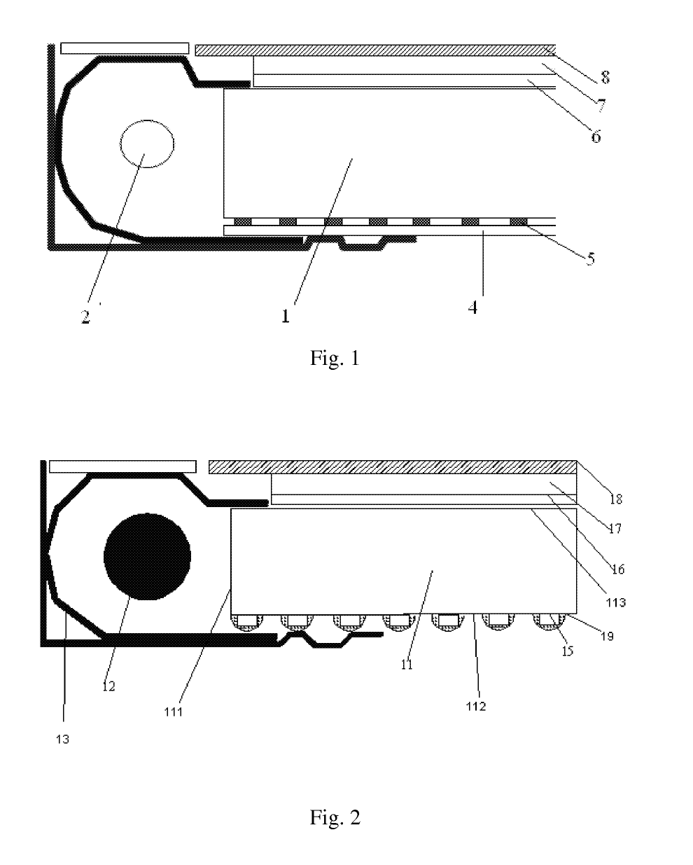

Hereinafter, implementations, functional features and advantages of the present disclosure will be further described with reference to embodiments thereof and the attached drawings.

### DETAILED DESCRIPTION

Referring to FIG. 2, there is shown a schematic partial cross-sectional view of a backlight module according to a first embodiment of the present disclosure. The backlight module comprises a light guide plate 11, a light source 12, a light source shade 13, a diffuser sheet 16, a prism sheet 17 and a backplate 18. The light source shade 13 accommodates the light source 12, and is disposed adjacent to a side of the light guide plate 11 to reflect light rays emitted by the light source 12 to the light guide plate 11. The diffuser sheet 16 and the prism sheet 17 are sequentially disposed on the light guide plate 11. The diffuser sheet 16 comprises particles for diffusing light rays that are projected from the light guide plate 11 to the diffuser sheet 16, so the light rays can propagate in a direction below the prism sheet 17 and a liquid crystal panel (not shown) until a visual angle is extended to cover up a pattern formed on the light guide plate 11. The prism sheet 17 converges within a certain angle the light diffused by the diffuser sheet 16 so as to improve brightness of the liquid crystal panel.

In this backlight module, a cold cathode fluorescent tube, a light emitting diode (LED) or an electroluminescence light source is used as the light source 12.

The light guide plate 11 may be made by cutting or injection molding a transparent light guide material such as an organic glass, polystyrene or a glass.

The light guide plate 11 has a light incident surface 111, a bottom surface 112 and a light exiting surface 113. The light incident surface 111 is a side, and the light source 12 is disposed opposite to the light incident surface 111. The bottom surface 112 and the light exiting surface 113 are planes in parallel with each other, and are adjacent to the light incident surface 111 respectively. The bottom surface 112 is formed with a plurality of mesh points 15 in the form of rectangular protrusions or round grooves, and the mesh points 15 are formed through embossing, printing or laser cutting. The mesh points 15 are disposed on the bottom surface and the light exiting surface at intrevals, and a density of the mesh points 15 may increase with a distance from the light source 12.

This embodiment differs from the prior art in that, the light guide plate 11 further comprises a reflective layer 19 which is a sputtered film disposed on the bottom surface 112. The sputtered film is formed of one of silver (Ag), aluminum (Al), copper (Cu), chromium (Cr), and alloys of any two of them, or may be formed of other reflective materials having a high reflectivity. FIG. 2 shows a structure of the light guide plate 11 of this embodiment in which the sputtered film is covered on a surface of each of the mesh points 15 to form the reflective layer 19 on the periphery of the mesh points 15. The reflective layer 19 is generally formed in a vacuum system filled with an inert gas. Specifically, under the action of a high-voltage electric field, the argon gas is ionized to generate an argon electron flow to bombard a target cathode; and then, atoms or molecules of the target material that are sputtered are deposited on the mesh points 15 to form the reflective layer 19. The sputtering process has advantages such as high speed, low temperature and low damage. Specifically, the high speed means that the speed of deposition is high; and the low temperature and the low damage mean that the temperature rise of the light guide plate 11 is low and the damage to the light guide plate 11 is small. Moreover, the reflective layer formed through sputtering has a high density and is distributed uniformly.

After the light rays emitted by the light source 12 pass into the light guide plate 11 from the light incident surface 111, the light rays propagate to the bottom surface 112 of the light guide plate 11. When encountering the mesh points 15, the light rays will be scattered by the mesh points 15 towards various directions; and when being projected outwards via the spacings among the mesh points 15, the light rays will be projected to the reflective layer 19. Because the reflective layer 19 is formed through sputtering and, thus, has a high reflectivity, most of the light rays are reflected back to the light guide plate 11. This ensures that the light rays are projected from the light exiting surface so as to be converged, which prevents leakage of the light rays and effectively improves the utilization factor of the light rays.

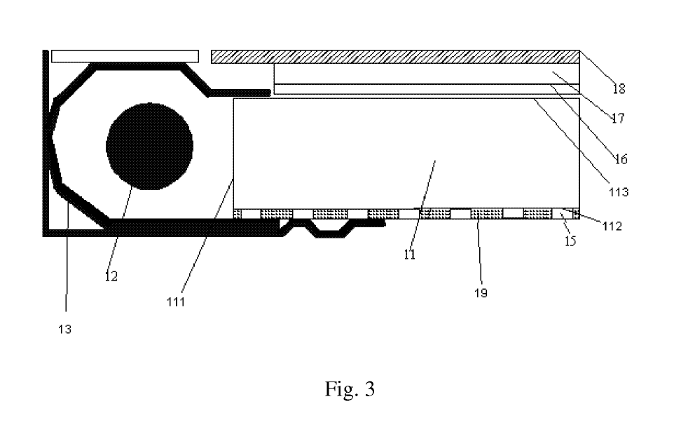

Referring to FIG. 3, there is shown a schematic partial cross-sectional view of the backlight module according to a second embodiment of the present disclosure. Likewise, the bottom surface 112 of the light guide plate 11 is formed with a plurality of mesh points 15 in the form of rectangular protrusions or round grooves. The sputtered film is covered on the bottom surface of the light guide plate 11, i.e., on the spacings among the mesh points 15; and the sputtered film may also be covered on a surface of each of the mesh points 15 to form a reflective layer 19. The reflective layer 19 in combination with the mesh points 15 enables total reflection of the light rays that have passed into the light guide plate 11 as far as possible.

The light source 12 is disposed at the side of the light incident surface of the light guide plate 11, so as a distance from the light source 12 increases, the closer to the middle of the light guide plate 11 the light rays that have passed into the light guide plate 11 become, the larger the damage will be. In order to make up for the loss of the light rays, the density of the sputtered film may be set to increase with the distance from the light source 12 so as to improve the refractive index of the light rays.

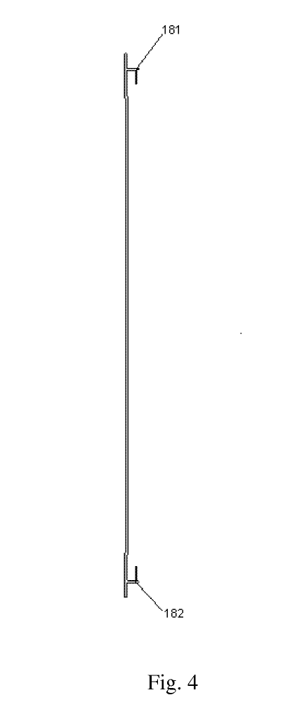

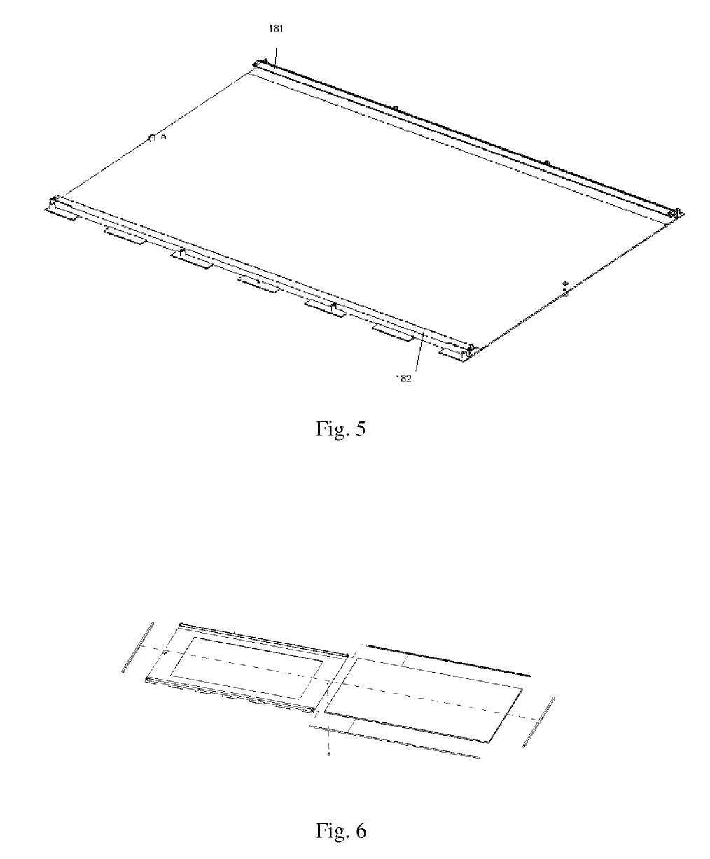

The light guide plate 11 has the prior art light guide plate and reflective sheet integrated together, so the structure of the backlight module becomes thinner. As a result, it is possible to push components of the backlight module into the backplate 18 from a side during the assembling process. As shown in FIG. 4, FIG. 5 and FIG. 6, two parallel grooves 181 and 182 are disposed at two sides of the backplate 18, and the height of each of the grooves 181 and 182 is no less than the thickness of all the components of the backlight module that are superimposed together. In the assembling process, the components such as the diffuser sheet 16 and the prism sheet 17 are firstly attached to the light guide plate 11 by means of an adhesive tape or a gluewater, and then pushed into the backplate 18 from a side along the grooves 181 and 182. The light guide plate 11 may be positioned through a combination of a fixed stud and a movable stud; i.e., upon the light guide plate 11 is pushed into an expected position, the movable stud is locked to fix the aforesaid components at expected positions. Alternatively, the light guide plate 11 may also be fixed to the backplate by means of movable screws.

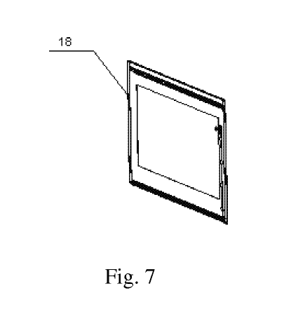

Further, the backplate 18 may be formed as a hollow structure as shown in FIG. 7. The backlight module of the present disclosure is free of the reflective sheet, so the backplate 18 does not need to support the reflective sheet and, thus, can support all the components including the light guide plate 11. This structure can reduce the cost.

The backplate 18 may be formed by two L-shaped metal plates welded together and then stamped so as to increase convenience of inserting the light guide plate 11 from a side of the backplate 18. A backplate 18 having a small size may be directly formed through plastic injection molding or metal die-casting.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

What is claimed is:

1. A light guide plate, comprising a bottom surface and a reflective layer, the bottom surface being formed with a plurality of mesh points, and a density of the mesh points increasing with a distance from a light source, wherein the reflective layer is a sputtered film formed on the bottom surface.

2. The light guide plate of claim 1, wherein the sputtered film is formed on a surface of each of the mesh points.

3. The light guide plate of claim 1, wherein the sputtered film is formed of one of silver (Ag), aluminum (Al), copper (Cu), chromium (Cr), and any alloys thereof.

4. The light guide plate of claim 2, wherein the sputtered film is formed of one of silver (Ag), aluminum (Al), copper (Cu), chromium (Cr), and any alloys thereof.

5. A backlight module, comprising a light guide plate and a light source, the light guide plate comprising a light incident surface, a bottom surface and a reflective layer, and the light source being disposed at the side of the light incident surface, wherein the reflective layer is a sputtered film formed on the bottom surface.

6. The backlight module of claim 5, wherein the sputtered film is formed on a surface of each of the mesh points.

7. The backlight module of claim 5, wherein the sputtered film is formed of one of silver (Ag), aluminum (Al), copper (Cu), chromium (Cr), and any alloys thereof.

8. The backlight module of claim 6, wherein the sputtered film is formed of one of silver (Ag), aluminum (Al), copper (Cu), chromium (Cr), and any alloys thereof.

9. The backlight module of claim 5, wherein a density of the sputtered film increases with a distance from the light source.

10. The backlight module of claim 6, wherein a density of the sputtered film increases with a distance from the light source.

11. The backlight module of claim 5, further comprising a backplate, wherein the backplate is formed with two grooves at two sides respectively, and the light guide plate is snap-fitted in the two grooves and fixed to the backplate by means of movable screws or movable studs.

12. The backlight module of claim 6, further comprising a backplate, wherein the backplate is formed with two grooves at two sides respectively, and the light guide plate is snap-fitted in the two grooves and fixed to the backplate by means of movable screws or movable studs.

13. The backlight module of claim 11, wherein the backplate is a hollow structure.

14. The backlight module of claim 13, wherein the backplate is formed by two L-shaped metal plates welded together.

15. A backlight module, comprising a light guide plate, a light source and a backplate, the light guide plate comprising a light incident surface, a bottom surface and a reflective layer, the light source being disposed at the side of the light incident surface, the light guide plate being formed with a plurality of mesh points on a bottom surface thereof, and a density of the mesh points increasing with a distance from the light source, wherein the reflective layer is a sputtered film formed on the bottom surface, and a density of the sputtered film increases with a distance from the light source;
the backplate is formed with two grooves at two sides respectively, and the light guide plate is snap-fitted in the two grooves and fixed to the backplate by means of movable screws or movable studs.

16. The backlight module of claim 15, wherein the sputtered film is formed on a surface of each of the mesh points.

17. The backlight module of claim 15, wherein the sputtered film is formed of one of silver (Ag), aluminum (Al), copper (Cu), chromium (Cr), and any alloys thereof.

18. The backlight module of claim 16, wherein the sputtered film is formed of one of silver (Ag), aluminum (Al), copper (Cu), chromium (Cr), and any alloys thereof.

19. The backlight module of claim 15, wherein the backplate is a hollow structure.

20. The backlight module of claim 19, wherein the backplate is formed by two L-shaped metal plates welded together.
